(19) United States
(12) Patent Application Publication
(10) Pub. No.: US 2007/0183594 A1
(43) Pub. Date: Aug. 9, 2007

(54) Data processing apparatus for performing a cryptographic method

(75) Inventor: Mark Julian Russell, Maidenhead (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY UNITED KINGDOM LIMITED, Weybridge (GB)

(21) Appl. No.: 11/440,109

(22) Filed: May 25, 2006

(30) Foreign Application Priority Data
May 27, 2005 (GB) 0510926.9

(51) Int. Cl. H04L 9/28

(52) U.S. Cl. 380/28

(57) ABSTRACT

An encoding data processing apparatus operable to execute a cryptographic method to form an encrypted ciphertext sequence of data symbols from an input plaintext sequence of data symbols, said cryptographic method comprising a plurality of functional stages, said encoding data processing apparatus comprising: a plurality of data processing units arranged to form a pipeline, each of said data processing units being operable to process, in accordance with a respective functional stage of said cryptographic method, an input data quantity to produce a corresponding processed data quantity, said processed data quantity being fed to a subsequent data processing unit in said pipeline; and a combination element operable to form said encrypted ciphertext sequence of data symbols based on a combination of said processed data quantities output from a final one of said data processing units of said pipeline and said input plaintext sequence of data symbols; wherein said data processing apparatus is operable, during an initialization stage, to supply sequentially to a first one of said data processing units a series of two or more initialization values as said input data quantities to said pipeline, said data processing apparatus being operable to commence a main processing stage, in which said input data quantity to said first data processing unit is formed from an output of said final data processing unit of said pipeline, only after all of said initialization values have been supplied to said first data processing unit during said initialization stage. Embodiments of the invention, when performing encryption in the OFB or CFB mode of operation, initialize the encryption apparatus with a series of two or more initialization values during an initialization stage. This enables the elimination of any processing delay caused by the encryption algorithm having to wait for an encrypted data quantity output from the encryption algorithm to be fed back to the input of the encryption algorithm.

### BACKGROUND OF THE INVENTION

1. Field of the Invention

The present invention relates to data processing apparatus and methods, operable to execute a cryptographic method to form an encrypted ciphertext sequence of data symbols from an input plaintext sequence of data symbols or to form a plaintext sequence of data symbols from an input encrypted ciphertext sequence of data symbols.

2. Description of the Prior Art

Encryption and decryption of data are well known and many algorithms exist for securing data, such as: the Data Encryption Standard (DES) (for which see http://csrc.nist.gov/publications/fips/fips46-3/fips46-3.pdf); the Rijndael encryption algorithm (for which see http://csrc.nist.gov/publications/fips/fips197/fips-197.pdf); and the Rivest-Shamir-Adleman (RSA) encryption algorithm (for which see “The Handbook of Applied Cryptography”, ISBN 0-8493-8523-7); etc. The purpose of these encryption algorithms is to transform an input sequence of data symbols, referred to as plaintext (unencrypted) data, into an encrypted sequence of data symbols, referred to as ciphertext data, that has been secured in such a way that it is computationally infeasible to recover the input data from the encrypted data without prior knowledge of key information. If this key information is known, then it is relatively straightforward to recover the original plaintext data via a corresponding decryption algorithm.

An encryption algorithm may be used in a variety of so-called “modes of operation”, which are well-known in this field of technology. For example, in the so-called “electronic codebook (ECB)” mode of operation, an input plaintext data quantity is simply passed through the encryption algorithm to yield a corresponding output ciphertext data quantity. However, in other modes of operation, such as the so-called “output feedback (OFB)” mode and the “cipher feedback (CFB)” mode, the encryption algorithm is used with a degree of feedback. This feedback comprises taking a ciphertext data quantity output from the encryption algorithm and re-applying it to the input of the encryption algorithm. The difference between the OFB and the CFB modes of operation is in how and when this output ciphertext data quantity is combined with an input plaintext data quantity.

The OFB and CFB modes of operation are often preferred to the more basic ECB mode of operation as they are considered to be more cryptographically secure, i.e. data encrypted under the ECB mode of operation is more vulnerable to certain “attacks” than if that data had been encrypted under one of the OFB or CFB modes of operation. However, due to the nature of the feedback required by the OFB and CFB modes of operation, hardware and/or software implementations of these modes of operation invariably have a lower data throughput rate than the ECB mode of operation. This can be particularly problematic when a high degree of security is required when encrypting, in real-time, input plaintext data of a high data rate, such as audio/video data.

### SUMMARY OF THE INVENTION

An object of the present invention is to provide an encoding data processing apparatus operable to execute a cryptographic method to form an encrypted ciphertext sequence of data symbols from an input plaintext sequence of data symbols, in which a rate of processing the input plaintext sequence of data symbols is increased.

According to an aspect of the invention, there is provided an encoding data processing apparatus operable to execute a cryptographic method to form an encrypted ciphertext sequence of data symbols from an input plaintext sequence of data symbols, said cryptographic method comprising a plurality of functional stages, said encoding data processing apparatus comprising: a plurality of data processing units arranged to form a pipeline, each of said data processing units being operable to process, in accordance with a respective functional stage of said cryptographic method, an input data quantity to produce a corresponding processed data quantity, said processed data quantity being fed to a subsequent data processing unit in said pipeline; and a combination element operable to form said encrypted ciphertext sequence of data symbols based on a combination of said processed data quantities output from a final one of said data processing units of said pipeline and said input plaintext sequence of data symbols; wherein said data processing apparatus is operable, during an initialization stage, to supply sequentially to a first one of said data processing units a series of two or more initialization values as said input data quantities to said pipeline, said data processing apparatus being operable to commence a main processing stage, in which said input data quantity to said first data processing unit is formed from an output of said final data processing unit of said pipeline, only after all of said initialization values have been supplied to said first data processing unit during said initialization stage.

Embodiments of the invention, when performing encryption in the OFB or CFB mode of operation, initialize the encryption apparatus with a series of two or more initialization values (as opposed to a conventional single initialization value) during an initialization stage. These initialization values are supplied sequentially to the encryption apparatus. Once this initialization stage has been completed, the encryption enters a main processing stage in which the feedback of the encryption is then commenced. However, the use of a plurality of initialization values effectively establishes a plurality of independent interleaved data sequences, each generated from a corresponding initialization value. This enables a reduction of a of processing delay caused by the encryption algorithm having to wait for an encrypted data quantity output from the encryption algorithm to be fed back to the input of the encryption algorithm, thereby enabling an increased data rate for the input plaintext data. As will be appreciated therefore, embodiments of the present invention can therefore provide an increase in a rate at which plaintext is encrypted.

Further respective aspects and features of the invention are defined in the appended claims.

### BRIEF DESCRIPTION OF THE DRAWINGS

The above and other objects, features and advantages of this invention will be apparent from the following detailed description of illustrative embodiments which is to be read in connection with the accompanying drawings, in which;

FIG. 1 schematically illustrates a general encryption and decryption system;

FIG. 2 schematically illustrates an example of using encryption and decryption for video data;

FIG. 3 schematically illustrates an overview of the Rijndael encryption algorithm;

FIG. 4A schematically illustrates an OFB mode of operation for an encryption algorithm;

FIG. 4B schematically illustrates a CFB mode of operation for an encryption algorithm;

FIG. 5 schematically illustrates decryption in the CFB mode of operation;

FIG. 6A schematically illustrates a pipelined implementation of the Rijndael encryption algorithm being used in the OFB mode;

FIG. 6B schematically illustrates the situation as shown in FIG. 6A once an amount of data processing has been completed;

FIG. 6C schematically illustrates the situation as shown in FIG. 6B once an amount of data processing has been completed;

FIG. 7A schematically illustrates a first embodiment of the invention;

FIG. 7B schematically illustrates the situation as shown in FIG. 7A once an amount of data processing has been completed;

FIG. 7C schematically illustrates the situation as shown in FIG. 7B once an amount of data processing has been completed;

FIG. 8A schematically illustrates a further embodiment of the invention; and

FIG. 8B schematically illustrates the situation as shown in FIG. 8A once an amount of data processing has been completed.

### DESCRIPTION OF THE PREFERRED EMBODIMENTS

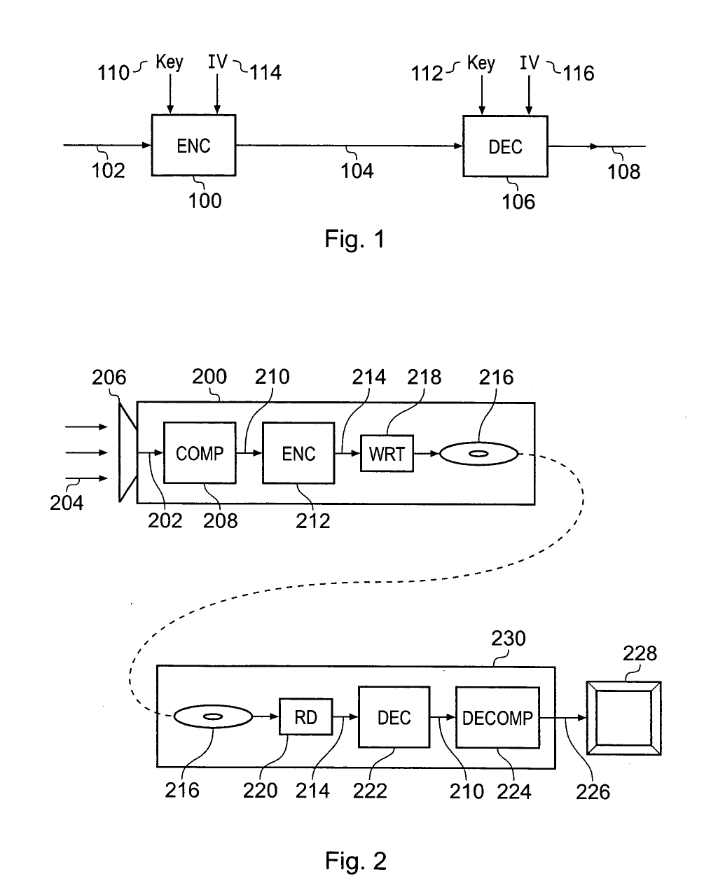

FIG. 1 schematically illustrates a general encryption and decryption system. An encryption processor 100 receives plaintext data 102 (unencrypted) and encrypts the plaintext data 102 to produce output ciphertext data 104. A decryption processor 106 receives the ciphertext data 104 and decrypts the ciphertext data 104 to produce output plaintext data 108. The encryption processor 100 may use any known encryption algorithm and the decryption processor 106 uses a corresponding, decryption algorithm. The encryption algorithm used by the encryption processor 100 may require the encryption processor 100 to make use of an encryption key 110. Similarly, the decryption algorithm used by the decryption processor 106 may require the decryption processor 106 to make use of a decryption key 112. The encryption algorithm is known as “symmetric” if the decryption key 112 is the same as the encryption key 110 or can be easily derived from the encryption key 110; otherwise the encryption algorithm is known as an “asymmetric” encryption algorithm. Additionally, the encryption processor 100 may require initialization using an initialization value 114. Similarly, the decryption processor 106 may require initialization using an initialization value 116. Generally, the initialization value 114 will be the same as the initialization value 116, although this need not necessarily be the case.

Security of the system is maintained by ensuring that the decryption key 112 (and therefore, in the case of a symmetric encryption algorithm, the encryption key 110 also) is kept secret. In general, the initialization values 114, 116 need not be kept secret in order to maintain the security of the system, although it is preferable if this is the case.

Encryption and decryption algorithms and the use of keys and initialization values are well known in the art and shall therefore not be described in detail herein except insofar as it is necessary to describe the embodiments of the invention.

FIG. 2 schematically illustrates an example of using encryption and decryption for video data. A video camera 200 produces digitised video data 202 from light 204 received by a lens 206 of the video camera 200. The video data 202 is compressed by a compression processor 208. The compression processor 208 may use any known data compression algorithm. The compression processor 208 produces output compressed video data 210 which is fed into an encryption processor 212, which operates in the same way as the encryption processor 100 in FIG. 1. Encrypted compressed video data 214 output from the encryption processor 212 is then written onto a recording medium 216 by a writing processor 218. The recording medium 216 may be, for example, an optical disc, a magnetic disc or a magnetic tape medium.

The recording medium 216 containing the encrypted compressed video data 214 may be used in conjunction with a video reproduction apparatus 230. A reading unit 220 reads the encrypted compressed video data 214 from the recording medium 216 and supplies the encrypted compressed video data 214 to a decryption processor 222. The decryption processor 222 operates in the same way as the decryption processor 106 in FIG. 1. The decryption processor 222 decrypts the encrypted compressed video data 214 to produce output compressed video data 210. A decompression processor 224 decompresses the compressed video data 210 to produce uncompressed video data 226. The uncompressed video data 226 is then displayed on a monitor 228.

It will be appreciated that the video data need not be compressed via the compression processor 208 and therefore need not be decompressed by the decompression processor 224, i.e. the encryption and decryption may be performed on baseband video data too. It will also be appreciated that the encrypted video data 214 need not necessarily be written onto the recording medium 216. Instead the video camera 200 could be connected to the video reproduction apparatus 230 via a cable or a network. Finally, it will be appreciated that whilst FIG. 2 does not show encryption and recording of audio data alongside the video data, audio data could be handled in a similar way as the video data.

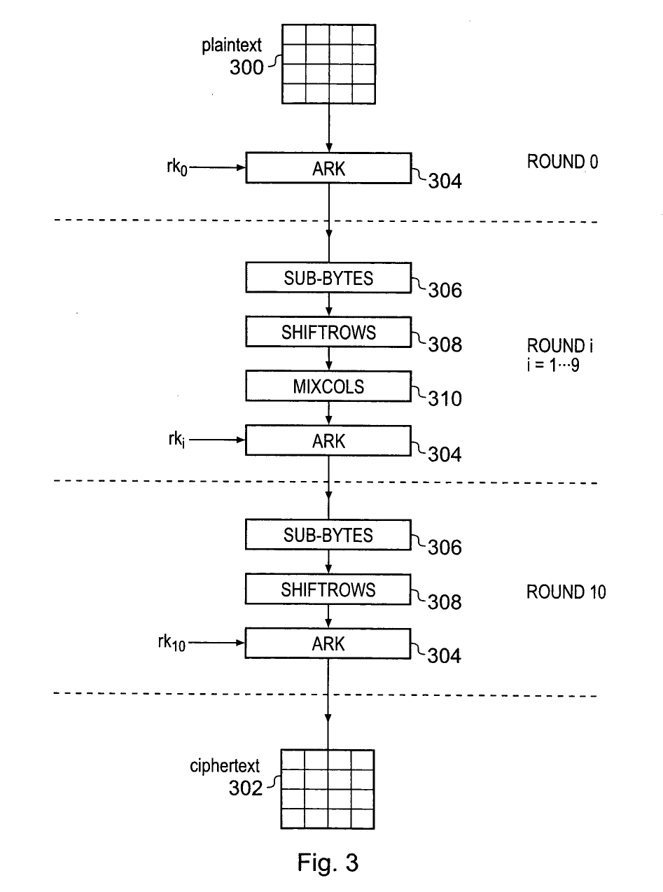

The current embodiment will be described with relation to the Rijndael encryption algorithm, although it will be appreciated that this is merely for exemplary purposes and any other encryption algorithm could be used in its place. The Rijndael encryption algorithm is a well known data encryption algorithm and details may be found at http://csrc.nist.gov/publications/fips/fips197/fips-197.pdf. A full description of the Rijndael encryption algorithm will therefore not be provided. However, FIG. 3 schematically illustrates an overview of the Rijndael encryption algorithm. There are several configurations of the Rijndael encryption algorithm—the one described herein operates on 128 bit blocks of data and uses 128 bit keys. A 128 bit block of plaintext data 300 may therefore be represented as a 4×4 array of 8 bit data words. The output of the Rijndael encryption is then a block of ciphertext data 302 that is also represented as a 4×4 array of 8 bit data words.

Before beginning the encryption, the Rijndael encryption algorithm produces so called “round-keys” rk₀, rk₁, . . . rk₁₀ from a main encryption key. This is performed according to a so called “key schedule” which is not shown in FIG. 3. Each of the round-keys rkᵢ is a 128 bit key derived from the main encryption key.

The encryption is performed in a series of eleven so called “rounds”. Each of the rounds has an associated round-key rkᵢ.

In the first round, round 0, the round-key rk₀ is added to the input plaintext data at an “add round-key (ARK)” stage 304.

The processing for round 1 begins at a “sub-bytes” stage 306. At the sub-bytes stage 306 each byte of the 128 bit data word currently being processed is substituted with a corresponding byte from a look up table (not shown in FIG. 3). Processing then continues at a “shift rows” stage 308 at which each of the rows of the 4×4 array representing the 128 bit data word currently being processed is shifted cyclically by a corresponding number of bytes. Processing then continues at a “mix columns” stage 310 at which each of the columns of the 4×4 array representing the 128 bit data word currently being processed is multiplied by a predetermined matrix. Round 1 is then completed by performing another add round-key stage 304, this time using the round-key rk₁.

Rounds 2 to 9 are identical to round 1 except that each round uses its corresponding round-key rkᵢ at the add round-key stage 304.

Round 10 is identical to rounds 1 to 9 except that it does not use a mix columns stage 310 and it uses its own round-key rk₁₀ at the add round-key stage 304. The output of round 10 is the ciphertext 302.

There are many ways in which an encryption algorithm may be used to encrypt plaintext data. The most simple of these involves supplying the input plaintext data to the input of an encryption processor 100 to produce the corresponding ciphertext at the output of the encryption processor 100 (similar to the processing flow shown in FIGS. 1 and 3).

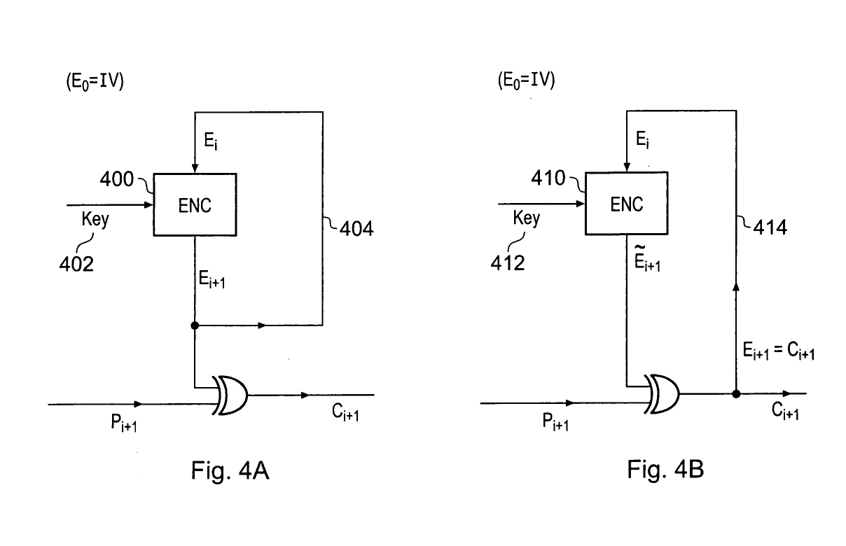

An alternative way of using an encryption algorithm is shown in FIG. 4A, which schematically illustrates an output feedback (OFB) mode of operation for an encryption algorithm. In FIG. 4A an encryption processor 400 makes use of a key 402 to encrypt an input data quantity Eᵢ to produce an output encrypted data quantity Eᵢ₊₁. The encrypted data quantity Eᵢ₊₁ is then fed back to the input of the encryption processor 400 via a feedback loop 404. The encryption is initialised by setting E₀ to be equal to an initialization value IV. In this way the encryption processor 400 outputs a sequence of pseudo-random cryptographically secure values Eᵢ₊₁ that may be XOR-ed with corresponding input plaintext data quantities Pᵢ₊₁, to produce output ciphertext data quantities Cᵢ₊₁. One of the advantages of the OFB mode is that the decryption mechanism is identical to the encryption mechanism. Hence, when decryption is performed using the OFB mode, the input plaintext data is actually the encrypted ciphertext data, whilst the output “encrypted data” is actually the decrypted plaintext data.

FIG. 4B schematically illustrates another mode of operation, the cipher feedback (CFB) mode of operation, for an encryption algorithm. An encryption processor 410 is supplied with a key 412. The processing in the CFB mode is identical to the processing in the OFB mode except that the feedback to the encryption processor 410 is via a feedback loop 414 taking the ciphertext data quantity Cᵢ₊₁ coming after the XOR instead of taking the direct output \tilde{E}ᵢ₊₁ from the encryption processor 410 (as would be the case in the OFB mode as shown in FIG. 4A). The encryption is initialised by setting Eo to be equal to an initialization value IV.

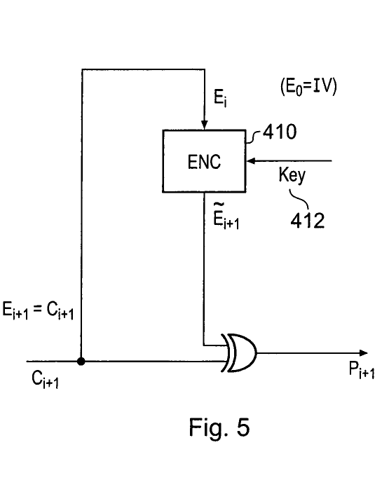

FIG. 5 schematically illustrates decryption in the CFB mode of operation. The encryption processor 410 of FIG. 4B is used during the decryption together with the same key 412. An input ciphertext data quantity Cᵢ₊₁ is XOR-ed with the output \tilde{E}ᵢ₊₁ of the encryption processor 410 to produce a corresponding decrypted plaintext data quantity Pᵢ₊₁. The input to the encryption processor comprises the preceding ciphertext data quantity Eᵢ=Cᵢ. The decryption is initialised by setting E₀ to be equal to an initialization value IV.

It will be appreciated from the description of the Rijndael encryption algorithm given above that the Rijndael encryption algorithm lends itself to a small hardware implementation, for example in an FPGA (Field Programmable Gate Array) or an ASIC (Application Specific Integrated Circuit). This is due to the large number of rounds and a commonality of the processing in each of the rounds, for example the add round-key stage 304, the sub-bytes stage 306, the shift rows stage 308 and the mix columns stage 310. It is possible to implement each one of these stages only once in the hardware and perform each of the rounds of the Rijndael encryption algorithm in series repeatedly re-using the same hardware. However, one of the problems with such a serial implementation is that the data rate is necessarily reduced. A pipelined implementation may therefore be preferable when the data rate of the input plaintext is large, for example for video data. In such a pipelined implementation, each of the rounds of the Rijndael encryption algorithm may have its own dedicated hardware. Whilst this increases the amount of hardware required for the implementation of the Rijndael encryption algorithm, the advantage is that the data rate through the Rijndael encryption algorithm is greatly increased. It will be appreciated that the benefits of such pipelining are not limited to the Rijndael encryption algorithm, but equally apply to other algorithms where one or more processing stages needs to be repeated.

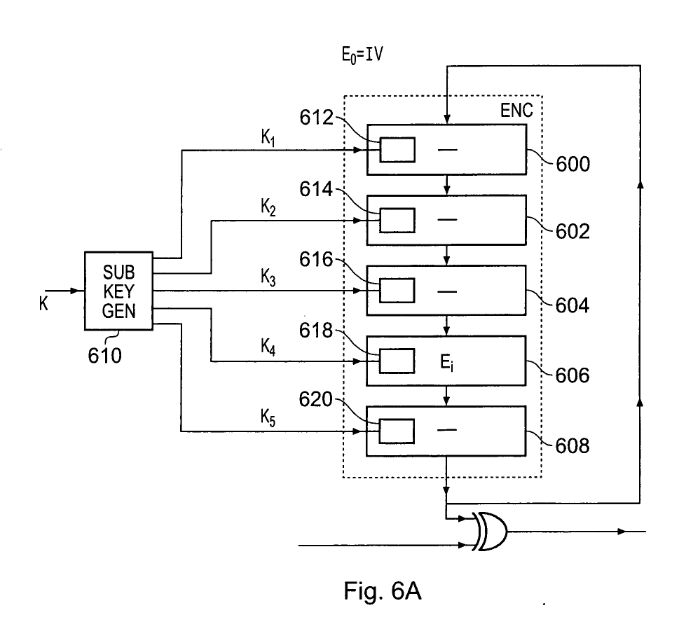

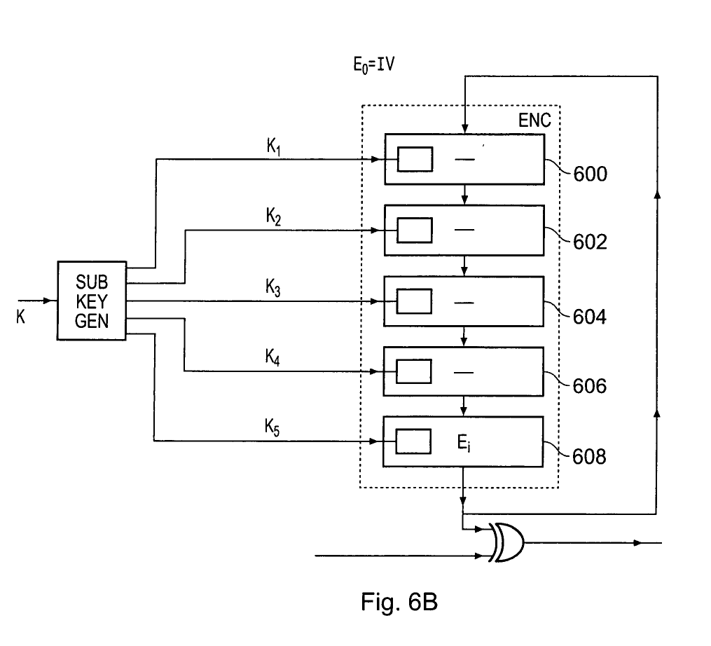

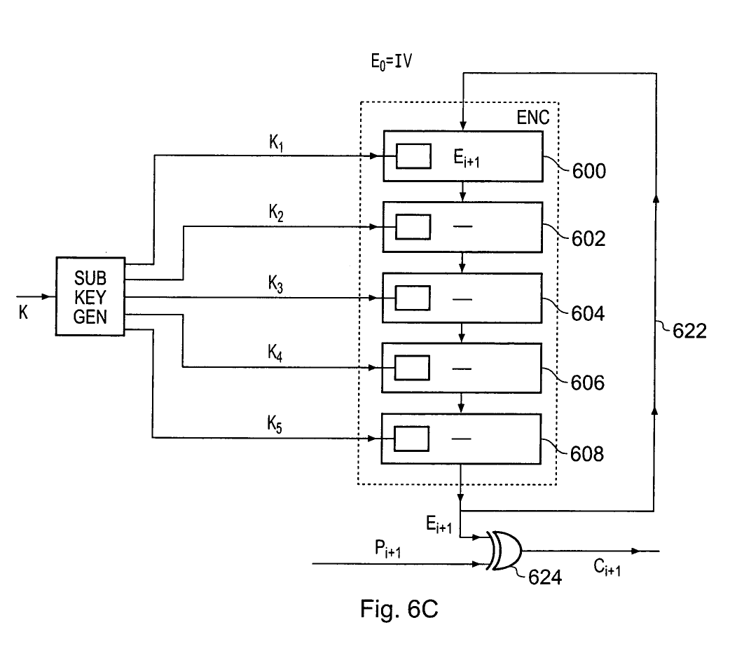

FIG. 6A schematically illustrates a pipelined implementation of the Rijndael encryption algorithm being used in the OFB mode. In the example shown in FIG. 6A there are five hardware data processing units 600, 602, 604, 606, 608 in the pipeline. However, it will be appreciated that any other number of hardware data processing units may be used in the pipeline as appropriate. Each of the data processing units 600, 602, 604, 606, 608 may perform one or more of the rounds of the Rijndael encryption algorithm (or even a portion of a. single round). A sub-key generator 610 produces the various round-keys rkᵢ required for the encryption algorithm from a master key K. The sub-key generator 610 supplies each of the data processing units 600, 602, 604, 606, 608 with corresponding subsets of rounds keys K₁, K₂, K₃, K₄, K₅ respectively, depending on which rounds of the Rijndael encryption algorithm each of the data processing units 600, 602, 604, 606, 608 is arranged to perform. The round-key subsets K₁, K₂, K₃, K₄, K₅ are stored in corresponding key stores 612, 614, 616, 618, 620 within the respective data processing units 600, 602, 604, 606, 608.

FIG. 6A shows the encryption at a stage where an input data quantity Eᵢ is currently being processed by the data processing unit 606. As the encryption is being performed in the output feedback mode, it is necessary to wait for the data quantity Eᵢto be fully encrypted before the output of the final data processing unit 608 can be fed back into the first data processing unit 600. Consequently in the situation as shown in FIG. 6A, the data processing units 600, 602, 604, 608 are in an idle state, i.e. they are not currently processing a data quantity.

FIG. 6B schematically illustrates the situation as shown in FIG. 6A once the data processing unit 606 has finished its processing for the data quantity Eᵢ. As shown in FIG. 6B, the data processing unit 608 is no longer idle and is performing the processing for the data quantity Eᵢ. In contrast the data processing unit 606 has now become idle.

FIG. 6C schematically illustrates the situation as shown in FIG. 6B once the data processing unit 608 has finished its processing for the data quantity Eᵢ. The output from the data processing unit 608, i.e. the data quantity Eᵢ₊₁, has been fed into the data processing unit 600 via a feedback loop 622. The data processing unit 600 is no longer idle as it is now performing its processing for data quantity Eᵢ₊₁. In contrast the data processing unit 608 has returned to an idle state.

At the same time, the data quantity Eᵢ₊₁ output from the final data processing unit 608 is fed to an combination element (in this case, an XOR operator 624) so that an input plaintext data quantity Pᵢ₊₁ may be combined with the data quantity Eᵢ₊₁ to produce a ciphertext data quantity Cᵢ₊₁.

Whilst a pipelined implementation of the Rijndael encryption algorithm would normally be considerably faster than a serial implementation of the Rijndael encryption algorithm, it will be appreciated from the descriptions of FIGS. 6A, 6B and 6C that when the Rijndael encryption algorithm is being used in the OFB mode, the pipelined implementation as shown in FIGS. 6A, 6B and 6C will not produce an improvement in the encryption data rate due to the under utilisation of various stages in the pipeline process. It will be appreciated, for the same reasons, that the same problem applies to encryption in the CFB mode (due to the feedback loop 414).

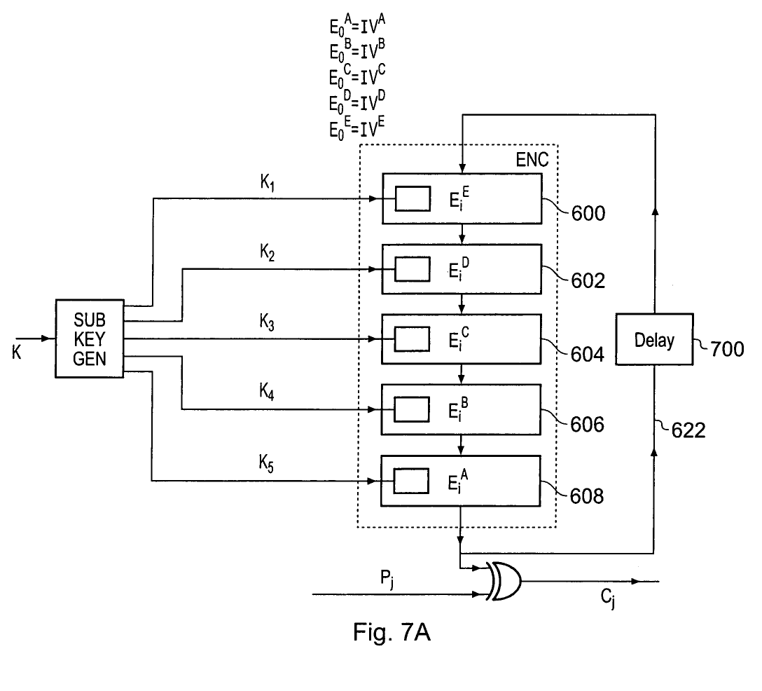

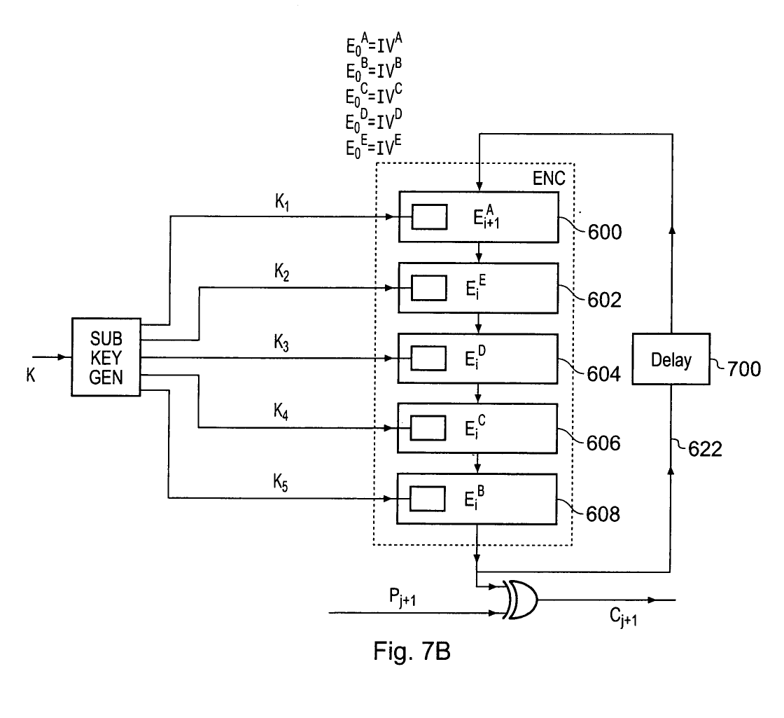

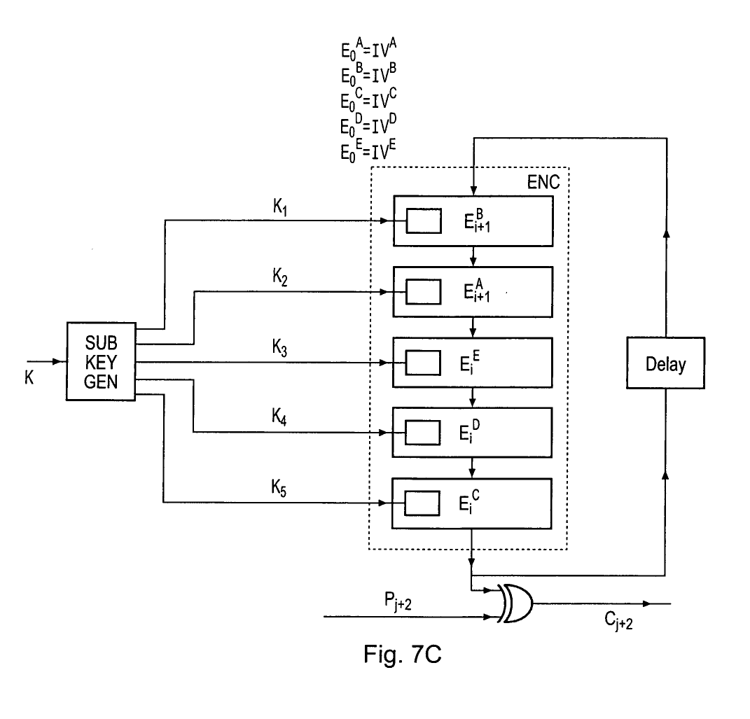

FIG. 7A schematically illustrates a first embodiment of the invention. The encryption arrangement shown in FIG. 7A is similar to that shown in FIG. 6A except that a delay unit 700 may now be positioned within the feedback loop 622. Additionally, instead of using a single initialization value IV, the encryption arrangement shown in FIG. 7A makes use of five initialization values IV^{A}, IV^{B}, IV^{C}, IV^{D}, IV^{E}. During an initialization stage, the first initialization value IV^{A} is fed into the first data processing unit 600 as an input data quantity E₀^{A}. Once the data processing unit 600 has finished processing the initialization value IV^{A}, it outputs the corresponding processed data quantity to the data processing unit 602. At the same time, the data processing unit 600 receives the next initialization value IV^{B} as an input data quantity E₀^{B}. This process of sequentially feeding in the initialization values IV^{A}, IV^{B}, IV^{C}, IV^{D}, IV^{E} continues until all of the initialization values have been fed into the data processing unit 600.

As can be seen from FIG. 7A, the number of initialization values is equal to the number of data processing units, which means that none of the data processing units 600, 602, 604, 606 and 608 is ever left in an idle state. Once the initialization stage has been completed, the processing may be seen as entering a main processing stage whereby the output from the final data processing unit 608 in the pipeline is fed back to the input of the first data processing unit 600. As will be evident from a comparison of FIG. 6A and FIG. 7A, the data processing unit 608 in FIG. 7A produces a data quantity at its output five times more frequently than the data processing unit 608 in FIG. 6A. Hence the arrangement shown in FIG. 7A is capable of encrypting input plaintext data at a much greater data rate than the arrangement shown in FIG. 6A.

The arrangement shown in FIG. 7A may be viewed as an implementation of the output feedback mode using a number, in this case five, of interleaved data sequences (A, B, C, D and E) that are being encrypted by the data processing units 600, 602, 604, 606, 608. In FIG. 7A, the data quantities for these interleaved data sequences are represented by Eᵢ^{A}, Eᵢ^{B}, Eᵢ^{C}, Eᵢ^{D} and Eᵢ^{E}.

FIG. 7B schematically illustrates the situation shown in FIG. 7A once each of the data processing units 600, 602, 604, 606, 608 have finished processing the data quantity that it is currently handling. The data processing unit 602 which, in FIG. 7A, was processing a data quantity for data sequence D, is now processing a data quantity for data sequence E output from the data processing unit 600. The situation is similar for the other data processing units 600, 604, 606, 608.

FIG. 7C schematically illustrates the situation shown in FIG. 7B once each of the data processing units 600, 602, 604, 606, 608 has finished processing the data quantity that it is currently handling.

It will be appreciated that the number of initialization values (or equivalently the number of interleaved data sequences) is related to the number of data processing units being used. In FIGS. 7A, 7B and 7C, for example, the number of initialization values being used is equal to the number of data processing units being used. If fewer initialization values were being used, then not all of the data processing units 600, 602, 604, 606, 608 would be being utilised at any given point in time, i.e. it would be expected that at least one of the data processing units 600, 602, 604, 606, 608 would enter an idle state at some point during the encryption. Therefore, preferably the number of initialization values is equal to the number of data processing units being used. However, the delay unit 700 may be included within the feedback loop 622 so that the number of initialization values may be greater than the number of data processing units being used. The delay introduced into the feedback loop 622 by the delay unit 700 is sufficient to ensure that all of the current data quantities associated with the interleaved data sequences can be stored in the encryption arrangement at the same time. It may be preferable, for example, to have the number of initialization values equal to a power of 2 so that the hardware implementation may be made easier.

The five initialization values IV^{A}, IV^{B}, IV^{C}, IV^{D}, IV^{E} may be chosen to be completely independent of each other. However, an alternative embodiment of the invention uses an initialization value generation stage, preceding the initialization stage. In this alternative embodiment, the arrangement shown in Figure7A is arranged to operate according to the arrangement shown in FIG. 6A. During this initialization value generation stage, a master initialization value is fed into the data processing unit 600 as data quantity E₀ in FIG. 6A. The first five data quantities E₁, E₂, E₃, E₄, E₅ output from the data processing unit 608 are then used as the five initialization values IV^{A}, IV^{B}, IV^{C}, IV^{D}, IV^{E} . Once the initialization value generation stage has been completed and the five initialization values IV^{A}, IV^{B}, IV^{C}, IV^{D}, IV^{E} have been generated as described above, the initialization stage and then the main processing stage may be begun.

It is often the case that the data rate of an implementation of an encryption algorithm must be set according to the data rate of the input plaintext data. For example, for compressed video data the video data may have been compressed to a predetermined target data rate and the encryption must therefore be run at the same target data rate if the encryption is to be performed in real-time. Consequently the number of data processing units being used (i.e. the degree of pipelining that is performed in the hardware implementation) and the number of initialization values being used may be determined by the data rate of the input plaintext data. If the data rate of the input plaintext data is not fixed, then the largest expected input data rate must be catered for in order to ensure real-time encryption. In general, the greater the number of data processing units and initialization values, the greater the data rate of the encryption.

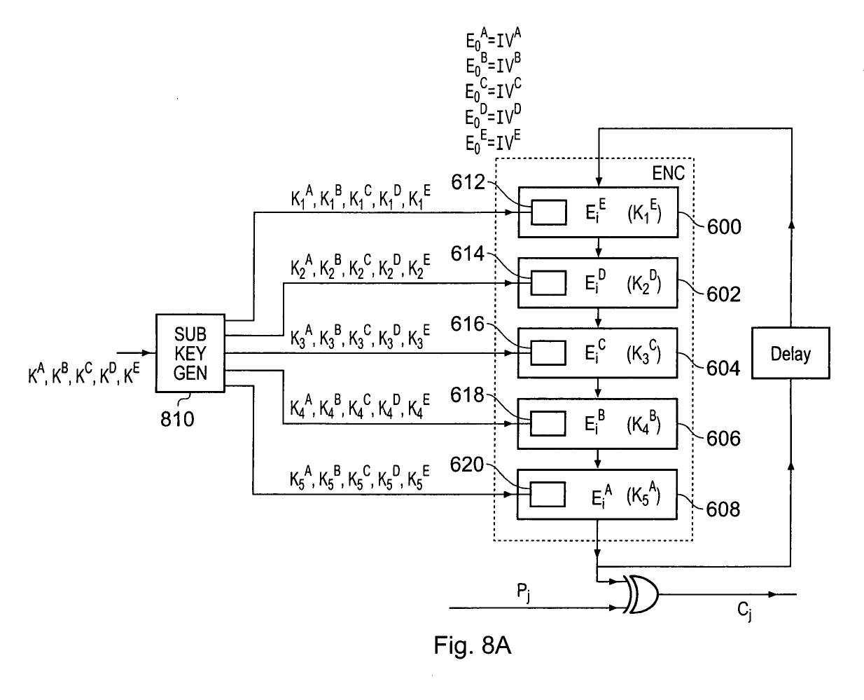

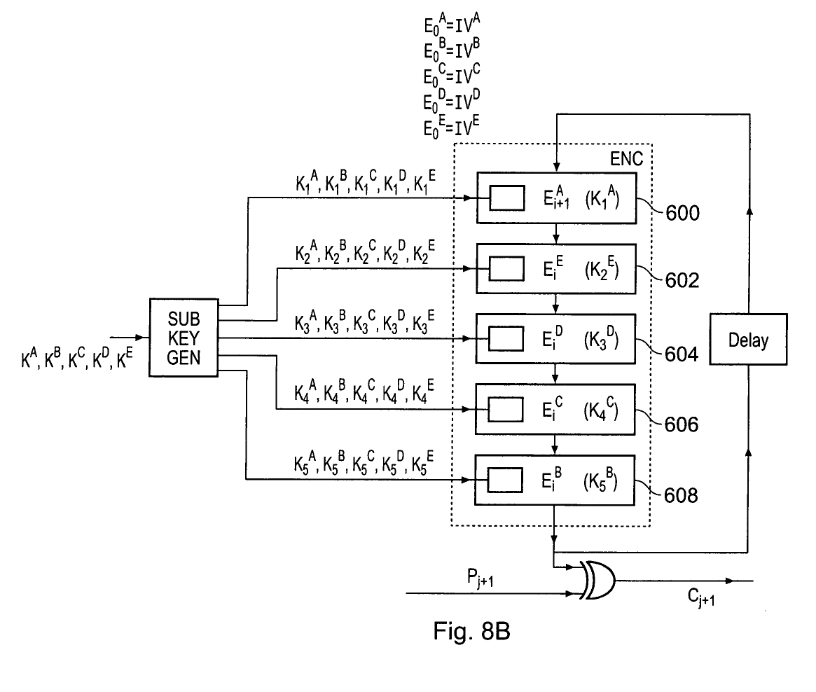

FIG. 8A schematically illustrates a further embodiment of the invention. The arrangement shown in FIG. 8A is identical to the arrangement shown in FIG. 7A except that a sub-key generator 810 is supplied with a plurality of master keys K^{A}, K^{B}, K^{C}, K^{D}, K^{E} instead of a single master key K. The sub-key generator 810 operates on each of the master keys K^{A}, K^{B}, K^{C}, K^{D}, K^{E} in exactly the same way as the sub-key generator 610 operated on the master key K. The sub-key generator 810 supplies each of the data processing units 600, 602, 604, 606, 608 with corresponding round-key subsets generated from each of the master keys K^{A}, K^{B}, K^{C}, K^{D}, K^{E} for storage in the round-key stores 612, 614, 616, 618, 620.

In the arrangement shown in FIG. 8A, the number of master keys is equal to the number of initialization vectors. However, it will be appreciated that this need not necessarily be the case and that a greater number or a lesser number of master keys could be used instead.

In FIG. 8A the round-keys that are used by each of the data processing units 600, 602, 604, 606, 608 is dependent upon which of the interleaved data sequences A, B, C, D, E is currently being processed by that data processing unit, i.e. the round-keys used by the data processing unit are dependent upon which of the initialization values IV^{A}, IV^{B}, IV^{C}, IV^{D}, IV^{E} generated the current data quantity being processed by that data processing unit. For example, in FIG. 8A the data processing unit 604 is currently processing a data quantity for data sequence C and is therefore using round-keys generated from the master key K^{C}.

FIG. 8B schematically illustrates the situation shown in FIG. 8A once each of the data processing units 600, 602, 604, 606, 608 has finished processing the current data quantity that it is handling. As can be seen in FIG. 8B, the data processing unit 604 is now processing a data quantity from the data sequence D and is therefore using round-keys generated from the master key K^{D}.

In FIGS. 8A and 8B each of the initialization values IV^{A}, IV^{B}, IV^{C}, IV^{D}, IV^{E} has an associated master key K^{A}, K^{B}, K^{C}, K^{D}, K^{E}. However, it will be appreciated that other associations could be made with greater or fewer master keys.

FIGS. 7A, 7B, 7C, 8A and 8B illustrate embodiments of the invention operating in the OFB mode of operation. However, it will be appreciated that, due to the minor differences between the OFB and the CFB modes when encrypting and decrypting, the arrangements shown in these Figures can easily be adapted from the OFB mode to the CFB mode. Specifically, the differences are as shown in FIGS. 4A, 4B and 5 and relate merely to what constitutes the input to the encryption processors 400, 410.

For encryption in the CFB mode of operation, the only difference between CFB encryption and OFB encryption is what comprises the feedback. Consequently, the embodiments shown in FIGS. 7A, 7B, 7C, 8A and 8B would be adapted to CFB mode encryption by arranging for the feedback loop 622 to be connected after the XOR, thereby taking ciphertext data quantities Cⱼ instead of the immediate output of the fmal data processing unit 608. Everything else would operate as per OFB encryption as described above.

For decryption in the CFB mode of operation, the only difference between CFB decryption and OFB decryption (which itself is identical to OFB encryption) is what comprises the input to the first data processing unit 600. Consequently, the embodiments shown in FIGS. 7A, 7B, 7C, 8A and 8B would be adapted to CFB mode decryption by simply arranging for the feedback loop 622 to be arranged so as to supply the first data processing unit 600 with received plaintext data quantities Pⱼ (strictly speaking, the feedback loop 622 no longer comprises ‘feedback’). Everything else would operate as per OFB decryption as described above.

It will be appreciated that whilst the above embodiments of the invention have been described as hardware implementations, it is equally possible to implement the same encryption using software or a combination of hardware and software. In so far as the embodiments of the invention described above are implemented, at least in part, using software-controlled data processing apparatus, it will be appreciated that a computer program providing such software control and a transmission, storage or other medium by which such a computer program is provided are envisaged as aspects of the present invention.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. An encoding data processing apparatus operable to execute a cryptographic method to form an encrypted ciphertext sequence of data symbols from an input plaintext sequence of data symbols, said cryptographic method comprising a plurality of functional stages, said encoding data processing apparatus comprising:
a plurality of data processing units arranged to form a pipeline, each of said data processing units being operable to process, in accordance with a respective functional stage of said cryptographic method, an input data quantity to produce a corresponding processed data quantity, said processed data quantity being fed to a subsequent data processing unit in said pipeline; and
a combination element operable to form said encrypted ciphertext sequence of data symbols based on a combination of said processed data quantities output from a final one of said data processing units of said pipeline and said input plaintext sequence of data symbols;
wherein said data processing apparatus is operable, during an initialisation stage, to supply sequentially to a first one of said data processing units a series of two or more initialisation values as said input data quantities to said pipeline,
said data processing apparatus being operable to commence a main processing stage, in which said input data quantity to said first data processing unit is formed from an output of said final data processing unit of said pipeline, only after all of said initialisation values have been supplied to said first data processing unit during said initialisation stage.

2. A decoding data processing apparatus operable to execute a cryptographic method to form a plaintext sequence of data symbols from an input encrypted ciphertext sequence of data symbols, said cryptographic method comprising a plurality of functional stages, said decoding data processing apparatus comprising:
a plurality of data processing units arranged to form a pipeline, each of said data processing units being operable to process, in accordance with a respective functional stage of said cryptographic method, an input data quantity to produce a corresponding processed data quantity, said processed data quantity being fed to a subsequent data processing unit in said pipeline; and
a combination element operable to form said plaintext sequence of data symbols based on a combination of said processed data quantities output from a final one of said data processing units of said pipeline and said input encrypted ciphertext sequence of data symbols;
wherein said data processing apparatus is operable, during an initialisation stage, to supply sequentially to a first one of said data processing units a series of two or more initialisation values as said input data quantities to said pipeline,
said data processing apparatus being operable to commence a main processing stage, in which said input data quantity to said first data processing unit is formed from an output of said final data processing unit of said pipeline, only after all of said initialisation values have been supplied to said first data processing unit during said initialisation stage.

3. A decoding data processing apparatus operable to execute a cryptographic method to form a plaintext sequence of data symbols from an input encrypted ciphertext sequence of data symbols, said cryptographic method comprising a plurality of functional stages, said decoding data processing apparatus comprising:
a plurality of data processing units arranged to form a pipeline, each of said data processing units being operable to process, in accordance with a respective functional stage of said cryptographic method, an input data quantity to produce a corresponding processed data quantity, said processed data quantity being fed to a subsequent data processing unit in said pipeline; and
a combination element operable to form said plaintext sequence of data symbols based on a combination of said processed data quantities output from a final one of said data processing units of said pipeline and said input encrypted ciphertext sequence of data symbols;
wherein said data processing apparatus is operable, during an initialisation stage, to supply sequentially to a first one of said data processing units a series of two or more initialisation values as said input data quantities to said pipeline,
said data processing apparatus being operable to commence a main processing stage, in which said input data quantity to said first data processing unit is formed from said input encrypted ciphertext sequence of data symbols, only after all of said initialisation values have been supplied to said first data processing unit during said initialisation stage.

4. A data processing apparatus according to claim 1, wherein, in said main processing stage, said input data quantity to said first data processing unit is a processed data quantity output from said final data processing unit of said pipeline.

5. A data processing apparatus according to claim 1, wherein, in said main processing stage, said input data quantity to said first data processing unit is an encrypted ciphertext data symbol output from said combination element.

6. A data processing apparatus according to claim 1, wherein the number of said initialisation values and the number of said data processing units is such that the data rate of the output of said pipeline is greater than or equal to the data rate of said input sequence of data symbols.

7. A data processing apparatus according to claim 1, wherein said combination element is operable to XOR a processed data quantity output from said final data processing unit with an input data symbol.

8. A data processing apparatus according to claim 1, wherein the number of said initialisation values is dependent upon the number of said data processing units in said pipeline.

9. A data processing apparatus according to claim 1, wherein the number of said initialisation values is equal to the number of said data processing units in said pipeline.

10. A data processing apparatus according to claim 9, wherein the number of said initialisation values is greater than the number of said data processing units in said pipeline.

11. A data processing apparatus according to claim 10, comprising:
a delay element operable to delay said data quantities being input to said first data processing unit.

12. A data processing apparatus according to claim 1 operable, during an initialisation value generation stage preceding said initialisation stage, to supply said first data processing unit with a master initialisation value as an input data quantity, said processed data quantities output from said final data processing unit forming said series of two or more initialisation values.

13. A data processing apparatus according to claim 1 comprising:
a key value generator operable, during a sub-key generation stage preceding said initialisation stage, to generate, from a master-key value and in accordance with a sub-key value generation method of said cryptographic method, at least one sub-key value and to supply each of said generated sub-key values to a corresponding data processing unit, each of said data processing units being operable to use a supplied sub-key value in accordance with said respective functional stage of said cryptographic method.

14. A data processing apparatus according to claim 13, wherein said key value generator is operable to use a plurality of master-key values.

15. A data processing apparatus according to claim 14, wherein, for each initialisation value, there is a corresponding master-key value, each of said data processing units operable to use a supplied sub-key value being operable to use a supplied sub-key value generated from said master-key value corresponding to said initialisation value from which said data quantity currently being processed by said data processing unit has been generated.

16. A data processing apparatus according to claim 1, wherein said plaintext sequence of data symbols comprises audio and/or video data and said encrypted ciphertext sequence of data symbols comprises encrypted audio and/or video data.

17. A data processing apparatus according to claim 1, wherein said cryptographic method is in accordance with a Rijndael encryption/decryption method.

18. A data storage and/or retrieval apparatus comprising a data processing apparatus according to claim 1.

19. A system comprising two or more terminals, said terminals being operable to communicate data to each other over a network, each of said data processing terminals comprising a data processing apparatus according to claim 1 and operable to encrypt said communicated data sent over said network and/or to decrypt said communicated data received over said network.

20. An encoding data processing method operable to execute a cryptographic method to form an encrypted ciphertext sequence of data symbols from an input plaintext sequence of data symbols, said cryptographic method comprising a plurality of functional stages, said encoding data processing method comprising the steps of:
performing, in series, a plurality of data processing stages, each of said data processing stages comprising the steps of:
(i) processing, in accordance with a respective functional stage of said cryptographic method, an input data quantity to produce a corresponding processed data quantity; and
(ii) feeding said processed data quantity to a subsequent data processing stage; and
forming said encrypted ciphertext sequence of data symbols based on a combination of said processed data quantities output from a final one of said data processing stages and said input plaintext sequence of data symbols;
wherein said data processing method comprises:
an initialisation step for supplying sequentially to a first one of said data processing stages a series of two or more initialisation values as input data quantities; and
a main processing step for forming said input data quantity to said first data processing stage from an output of said final data processing stage, commencing only after all of said initialisation values have been supplied to said first data processing stage during said initialisation step.

21. A decoding data processing method operable to execute a cryptographic method to form a plaintext sequence of data symbols from an input encrypted ciphertext sequence of data symbols, said cryptographic method comprising a plurality of functional stages, said decoding data processing method comprising the steps of:
performing, in series, a plurality of data processing stages, each of said data processing stages comprising the steps of:
(i) processing, in accordance with a respective functional stage of said cryptographic method, an input data quantity to produce a corresponding processed data quantity; and
(ii) feeding said processed data quantity to a subsequent data processing stage; and
forming said plaintext sequence of data symbols based on a combination of said processed data quantities output from a final one of said data processing stages and said input encrypted ciphertext sequence of data symbols;
wherein said data processing method comprises:
an initialisation step for supplying sequentially to a first one of said data processing stages a series of two or more initialisation values as input data quantities; and
a main processing step for forming said input data quantity to said first data processing stage from an output of said fmal data processing stage, commencing only after all of said initialisation values have been supplied to said first data processing stage during said initialisation step.

22. A decoding data processing method operable to execute a cryptographic method to form a plaintext sequence of data symbols from an input encrypted ciphertext sequence of data symbols, said cryptographic method comprising a plurality of functional stages, said decoding data processing method comprising the steps of:
performing, in series, a plurality of data processing stages, each of said data processing stages comprising the steps of:
(i) processing, in accordance with a respective functional stage of said cryptographic method, an input data quantity to produce a corresponding processed data quantity; and
(ii) feeding said processed data quantity to a subsequent data processing stage; and
forming said plaintext sequence of data symbols based on a combination of said processed data quantities output from a final one of said data processing stages and said input encrypted ciphertext sequence of data symbols;
wherein said data processing method comprises:
an initialisation step for supplying sequentially to a first one of said data processing stages a series of two or more initialisation values as input data quantities; and
a main processing step for forming said input data quantity to said first data processing unit from said input encrypted ciphertext sequence of data symbols, commencing only after all of said initialisation values have been supplied to said first data processing stage during said initialisation step.

23. Computer software comprising program code for carrying out a method according to claim 20.

24. A providing medium for providing computer software according to claim 23.

25. A providing medium carrying encrypted ciphertext data that has been produced according to the method of claim 20.

26. A medium according to claim 24, wherein said medium is a storage medium.

27. A medium according to claim 24, wherein said medium is a transmission medium.

28. A signal comprising an encrypted ciphertext sequence of data symbols, said encrypted ciphertext sequence of data symbols having been produced according to an encoding data processing method operable to execute a cryptographic method to form said encrypted ciphertext sequence of data symbols from an input plaintext sequence of data symbols, said cryptographic method comprising a plurality of functional stages, said encoding data processing method comprising the steps of:
performing, in series, a plurality of data processing stages, each of said data processing stages comprising the steps of:
(i) processing, in accordance with a respective functional stage of said cryptographic method, an input data quantity to produce a corresponding processed data quantity; and
(ii) feeding said processed data quantity to a subsequent data processing stage; and
forming said encrypted ciphertext sequence of data symbols based on a combination of said processed data quantities output from a final one of said data processing stages and said input plaintext sequence of data symbols;
wherein said data processing method comprises:
an initialisation step for supplying sequentially to a first one of said data processing stages a series of two or more initialisation values as input data quantities;
a main processing step for forming said input data quantity to said first data processing stage from an output of said final data processing stage, commencing only after all of said initialisation values have been supplied to said first data processing stage during said initialisation step; and
a sub-key generation stage preceding said initialisation stage for generating, for each of a plurality of master-key values and in accordance with a sub-key value generation method of said cryptographic method, at least one sub-key value, each of said generated sub-key values being supplied to a corresponding data processing stage, each of said data processing stages being operable to use a supplied sub-key value in accordance with said respective functional stage of said cryptographic method; and
wherein, for each initialisation value, there is a corresponding master-key value, each of said data processing stages operable to use a supplied sub-key value being operable to use a supplied sub-key value generated from said master-key value corresponding to said initialisation value from which said data quantity currently being processed by said data processing stage has been generated.
